(19) United States
(12) Patent Application Publication
(10) Pub. No.: US 2024/0278122 A1
(43) Pub. Date: Aug. 22, 2024

(54) METHOD AND APPARATUS FOR CONSTRUCTING VIRTUAL SCENARIO, AND ELECTRONIC DEVICE, MEDIUM AND PRODUCT

(71) Applicant: Beijing Bytedance Network Technology Co., Ltd., Beijing (CN)

(72) Inventors: Jichang YANG, Beijing (CN); Mingda SHI, Beijing (CN); Jie WEN, Beijing (DE); Weifeng LIN, Beijing (CN); Yunlong MIAO, Beijing (CN); Haoyu CHEN, Beijing (CN)

(21) Appl. No.: 18/570,063

(22) PCT Filed: Sep. 29, 2022
(86) PCT No.: PCT/CN2022/122578

§ 371 Date: Dec. 13, 2023

(30) Foreign Application Priority Data
Oct. 19, 2021 (CN) 202111214420.6

(51) Int. Cl. A63F 13/52

(52) U.S. Cl. CPC A63F 13/52

(57) ABSTRACT

The present disclosure relates to a method and apparatus for constructing a virtual scene, an electronic device, a medium, and a product. The method for constructing a virtual scene includes: displaying a first interface corresponding to a real scene in response to a game starting event, wherein the first interface comprises a locating icon; constructing a virtual door for entering a game virtual scene on the first interface in response to trigging the locating icon on the first interface; and displaying the game virtual scene in response to trigging the virtual door.

The present disclosure claims the priority of Chinese Patent Application No. 202111214420.6 filed on Oct. 19, 2021, whose title is “a method and apparatus for constructing a virtual scenario, an electronic device, a medium and a product”, and the entire content disclosed by the Chinese patent application is incorporated herein by reference as part of the present disclosure.

### TECHNICAL FIELD

The present disclosure relates to the field of computer technology, and in particular, to a method and apparatus for constructing a virtual scene, an electronic device, a medium, and a product.

### BACKGROUND

When a user plays an interactive game cheerfully, the user mainly has an effective experience in the game by different game roles.

Exemplarily, when a user wants to play a game, the user may start a game client on a smart device and needs to select a predefined game role and experience mode in the game client to have simulative experience.

However, existing game playing manners are low in interestingness.

### SUMMARY

In order to solve the above technical problems or partially solve the above technical problems, the present disclosure provides a method and apparatus for constructing a virtual scene, an electronic device, a medium, and a product.

In the first aspect, the present disclosure provides a method for constructing a virtual scene, the method comprises:
displaying a first interface corresponding to a real scene in response to a game starting event, wherein the first interface comprises a locating icon;
constructing a virtual door for entering a game virtual scene on the first interface in response to trigging the locating icon on the first interface; and
displaying the game virtual scene in response to trigging the virtual door.

In a possible design, before the constructing the virtual door for entering the game virtual scene on the first interface in response to trigging the locating icon on the first interface, the method further comprises:
updating the first interface based on a movement of a terminal device.

In a possible design, the displaying the game virtual scene in response to trigging the virtual door comprises:
selecting an interactive scene type in the first interface, wherein the interactive scene type corresponds to a different game virtual scene; and
displaying the game virtual scene corresponding to the interactive scene type in response to triggering the virtual door.

In a possible design, the displaying the game virtual scene corresponding to the interactive scene type in response to triggering the virtual door comprises:
upon detecting that a distance between position coordinates of a virtual collider and position coordinates of the virtual door is smaller than a first preset threshold, displaying the game virtual scene corresponding to the interactive scene type, wherein the virtual collider is arranged at a preset position of the terminal device in the game virtual scene.

In a possible design, after the displaying the game virtual scene, the method further comprises:
obtaining position information of the virtual collider; and
determining collision warning prompt information according to the position information of the virtual collider and position information of a real object in the real scene.

In a possible design, the determining collision warning prompt information according to the position information of the virtual collider and the position information of the real object in the real scene comprises:
upon detecting that a distance between the position coordinates of the virtual collider and position coordinates of the real object in the real scene is smaller than a second preset threshold, displaying a first prompt information in a target interface corresponding to the game virtual scene.

In a possible design, the displaying the first prompt information in a target interface corresponding to the game virtual scene comprises:
highlighting a coordinate region of the real object in the target interface corresponding to the game virtual scene;
or, displaying an anti-collision indication icon at a position where the real object is located in the target interface corresponding to the game virtual scene.

In a possible design, the determining the collision warning prompt information according to the position information of the virtual collider and the position information of the real object in the real scene comprises:
upon detecting that the distance between the position coordinates of the virtual collider and the position coordinates of the real object in the real scene is smaller than the second preset threshold, generating a second prompt information, wherein the second prompt information is used for providing an anti-collision voice warning prompt.

In a second aspect, the present disclosure provides a constructing apparatus of a virtual scene, the constructing apparatus comprises:
a first display module, configured to display a first interface corresponding to a real scene in response to a game starting event, wherein the first interface comprises a locating icon;
a construction module, configured to construct a virtual door for entering a game virtual scene on the first interface in response to trigging the locating icon on the first interface; and
a second display module, configured to display the game virtual scene in response to trigging the virtual door.

In a possible design, the apparatus further comprises: an updating module,

The updating module is configured to update the first interface based on a movement of a terminal device.

In a possible design, the second display module includes: a selection unit and a display unit:
the selection unit is configured to select an interactive scene type in the first interface, where the interactive scene type corresponds to a different game virtual scene;
the display unit is configured to display the game virtual scene corresponding to the interactive scene type in response to triggering the virtual door.

In a possible design, the display unit is specifically configured to:
upon detecting that a distance between position coordinates of a virtual collider and position coordinates of the virtual door is smaller than a first preset threshold, display the game virtual scene corresponding to the interactive scene type, where the virtual collider is set at a preset position of the terminal device in the game virtual scene.

In a possible design, the apparatus further includes an obtaining module and a determination module,
the obtaining module is configured to obtain position information of the virtual collider;
the determination module is configured to determine collision warning prompt information according to the position information of the virtual collider and position information of a real object in the real scene.

In a possible design, the determination module is specifically configured to:
upon detecting that a distance between the position coordinates of the virtual collider and position coordinates of the real object in the real scene is smaller than a second preset threshold, display first prompt information in a target interface corresponding to the game virtual scene.

In a possible design, the determination module is specifically configured to:
highlight a coordinate region of the real object in the target interface corresponding to the game virtual scene;
or, display an anti-collision indication icon at a position the real object is located in the target interface corresponding to the game virtual scene.

In a possible design, the determination module is specifically configured to:
upon detecting that the distance between the position coordinates of the virtual collider and the position coordinates of the real object in the real scene is smaller than the second preset threshold, generate second prompt information, where the second prompt information is used for providing an anti-collision voice warning prompt.

In a third aspect, the present disclosure provides an electronic device, the electronic device comprises: a memory and a processors: the memory is configured to store program instructions: the processor is configured to call the program instructions in the memory to make the electronic device to implement the method for constructing a virtual scene in any possible design according to the first aspect and in the first aspect.

In a fourth aspect, the present disclosure provides a computer storage medium comprising computer instructions, and when the computer instructions run on an electronic device, the electronic device performs the method for constructing a virtual scene in any possible design according to the first aspect and in the first aspect.

In a fifth aspect, the present disclosure provides a computer program product, which, when running on a computer, causes the computer to perform the method for constructing a virtual scene in any possible design according to the first aspect and in the first aspect.

In the method and apparatus for constructing a virtual scene, an electronic device, a medium, and a product provided by the embodiments of the present disclosure, by constructing a virtual door for entering a game virtual scene in the real world in response to a game starting event triggered by a user, “crossing” from a scene of the real world to a virtual scene of a game world can be realized, allowing for immersive game experience for the user; and by displaying the game virtual scene in response to triggering the virtual door by the user, the user is allowed to have effective experience of the virtual scene of the game world in the scene of the real world. The interestingness of the game is enhanced, thereby improving the user's entertainment experience.

### BRIEF DESCRIPTION OF THE DRAWINGS

The drawings herein are incorporated into and form a part of the specification, show embodiments that comply with the present disclosure, and are used together with the specification to explain the principles of the present disclosure.

In order to explain the technical solutions in the embodiments of the present disclosure or the prior art more clearly, the drawings which are needed when the embodiments or the prior art are described will be briefly introduced below. Obviously, for those ordinary skilled in the art, other drawings may be obtained on the basis of these drawings without any creative effort.

FIG. 1 is a flowchart of a method for constructing a virtual scene provided in an embodiment of the present disclosure;

FIG. 2 is a schematic diagram of displaying of a locating icon interface provided in an embodiment of the present disclosure:

FIG. 3 is a schematic diagram of displaying of a virtual door interface provided in an embodiment of the present disclosure:

FIG. 4 is a flowchart of another method for constructing a virtual scene provided in an embodiment of the present disclosure:

FIG. 5 is a flowchart of a further another method for constructing a virtual scene provided in an embodiment of the present disclosure;

FIG. 6A to FIG. 6C are displaying schematic diagrams of game virtual scenes corresponding to different interactive scene types provided in an embodiment of the present disclosure; and

FIG. 7 is a structural schematic diagram of an apparatus for constructing a virtual scene provided in an embodiment of the present disclosure.

### DETAILED DESCRIPTION

In order to more clearly understand the above purposes, features, and benefits of the present disclosure, the solutions of the present disclosure will be further described below. It should be noted that the embodiments of the present disclosure and the features in the embodiments may be combined with each other without conflict.

Many details are set forth in the description below to facilitate to fully understand the present disclosure, but the present disclosure may be implemented by using the other manners which are different from those described herein; obviously, the embodiments in the specification are only a portion of the embodiments of the present disclosure, and not all embodiments.

Exemplarily, the present disclosure provides a method and apparatus for constructing a virtual scene, an electronic device, a medium, and a product. According to the present disclosure, by constructing a virtual door for entering a game virtual scene in the real world in response to a game starting event triggered by a user, “crossing” from a scene of the real world to a virtual scene of a game world can be realized, allowing for immersive game experience for the user; and by displaying the game virtual scene in response to triggering the virtual door by the user, the user is allowed to have effective experience of the virtual scene of the game world in the scene of the real world. The interestingness of the game is enhanced, thereby improving the user's entertainment experience.

The method for constructing a virtual scene provided in the present disclosure is performed by a client installed on an electronic device. The electronic device is capable of moving autonomously or moving along with a carrier. The electronic device may be, for example, a device such as a Pad, a mobile phone, a wearable device, a vehicle-mounted device, an augmented reality (AR)/virtual reality (VR) device, a laptop, an ultra-mobile personal computer (UMPC), a netbook, and a personal digital assistant (PDA). The present disclosure has no any limitation on the specific type of the electronic device.

The present disclosure has no limitation on the type of an operating system of the electronic device. For example, the operating system may be Android system, iOS system, and the like.

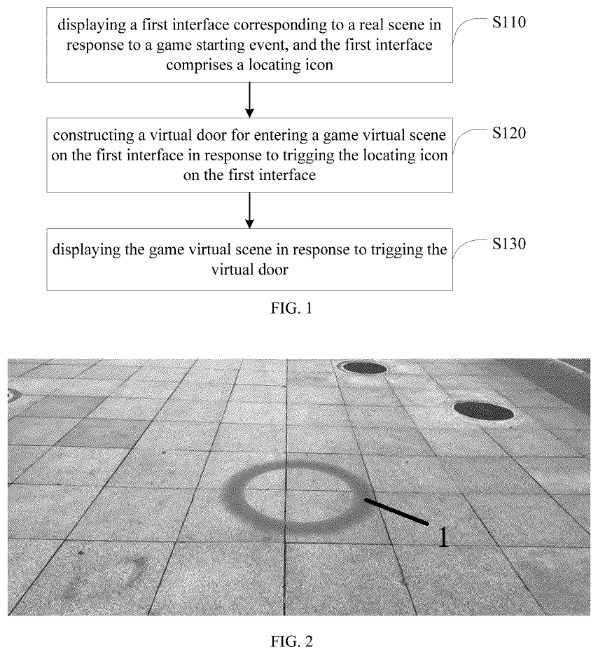

FIG. 1 is a flowchart of a method for constructing a virtual scene provided in an embodiment of the present disclosure. As shown in FIG. 1, the method for constructing a virtual scene provided in the present disclosure may include the following steps.

S110, displaying a first interface corresponding to a real scene in response to a game starting event, wherein the first interface includes a locating icon.

The first interface is a shot interface obtained by photographing a scene of the real world using a camera of a terminal device when the game is started.

As shown in FIG. 2 exemplarily, when a user initiates a game client to enter a game mode, a locating icon will be displayed in the shot interface obtained by photographing the scene of the real world where the user stays using the camera of the terminal device used by the user.

The locating icon may be correspondingly displayed at a position in the shot interface, allowing the user to locate a display position of a virtual door.

The locating icon may be displayed on the first interface in a circular shape 1 exemplarily shown in FIG. 2, or may be displayed on the first interface in a shape other than the shape included in the shot interface, providing a visual indication for the user.

In addition, the locating icon may be highlighted in the first interface. Thus, a degree of identification of the locating icon in the first interface can be effectively increased.

Highlighting the locating icon may be implemented in the following ways.

In some embodiments, highlighting the locating icon may be implemented by emphasizing a border, content, and the like of the locating icon using a color with high brightness.

In some other embodiments, highlighting the locating icon may be implemented by making the locating icon to flicker sequentially with high brightness and low brightness.

In some other embodiments highlighting the locating icon may be implemented by making the border of the locating icon to scale up and scale down orderly.

S120, constructing a virtual door for entering a game virtual scene on the first interface in response to trigging the locating icon on the first interface.

The virtual door of the game virtual scene may be constructed at a position in the scene of the real world. The user may switch the current scene from the scene of the real world to the virtual scene of the game world through the virtual door.

The virtual door of the game virtual scene may be configured to switch the scene from the real world to the game world and may also be configured to switch the scene from the game world to the real world.

Exemplarily, in switching the scene from the real world to the game world, the virtual door may serve as a virtual entrance for the user to enter the game world from the real world. In switching the scene from the game world to the real world, the virtual door may serve as a virtual exit for the user to come back to the real world from the game world.

It needs to be noted that the construction position of the virtual door may be determined based on a region captured by the camera of the terminal device used by the user.

Exemplarily, when the user initiates the game client installed on the terminal device, a regional picture taken by the camera of the terminal device will be displayed on a display interface of the game client, and the virtual door may be constructed at a position without a shelter in the regional picture. If the regional picture is a plot of flat ground, the virtual door may be constructed at a position in the flat ground to be displayed on the display interface of the game client. Thus, the user can find the virtual door rapidly and conveniently.

Wherein, the user may perform a triggering operation in the first interface to trigger the locating icon in the first interface.

Exemplarily, the user may perform the triggering operation on the locating icon in the first interface to logically trigger the locating icon in the first interface.

Exemplarily, the user may perform the triggering operation at any position in the first interface to logically trigger the locating icon in the first interface.

The triggering operation may include: single click, double click, sliding, etc. The present disclosure has no limitation on the triggering operation.

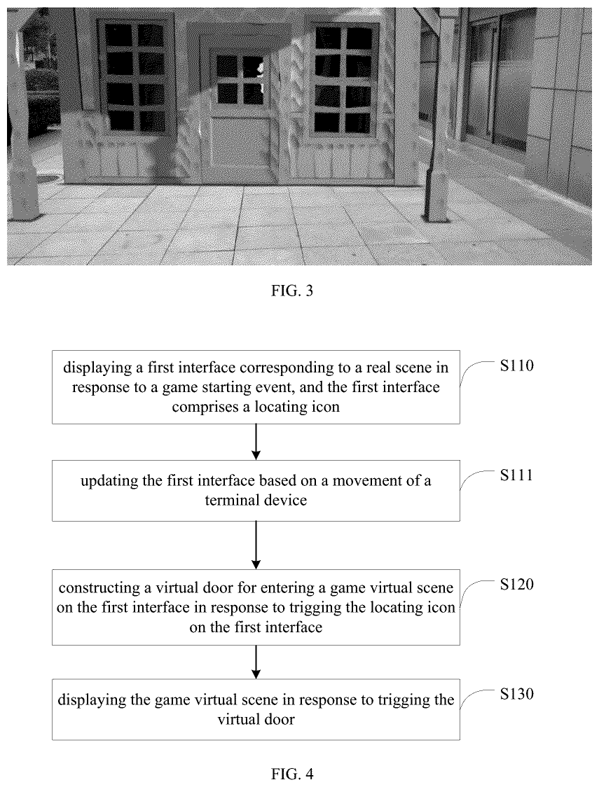

The virtual door of the game virtual scene may be displayed as exemplarily shown in FIG. 3. The display position of the virtual door in the first interface may correspond to a display position of the locating icon in the first interface.

Exemplarily, the display position of the virtual door in the first interface may be the same as the display position of the locating icon in the first interface, or, the display position of the virtual door in the first interface may be different from the display position of the locating icon in the first interface. For example, a position capable of accommodating the entire outline of the virtual door may be determined according to a display region of the first interface as the display position of the virtual door in the first interface.

Thus, the display position of the virtual door is demarcated using the locating icon in the first interface, and then the virtual door for entering the game virtual scene is constructed on the first interface in response to trigging the locating icon on the first interface. Thus, the user can accurately locate the virtual door leading to the virtual scene of the game world.

S130, displaying the game virtual scene in response to trigging the virtual door.

When the electronic device receives a trigger of the user to the virtual door, the game virtual scene may be displayed in the current display interface of the game client, allowing the user to experience and browse virtual objects in the game virtual scene by moving the terminal device.

The game virtual scene may be filled with three-dimensional materials made in advance. The three-dimensional materials may include a self-defined and created three-dimensional model. Data visitors are topologized to update the three-dimensional model, and an output format corresponding to the model will be exported to software which draws a map. A corresponding map is drawn by the model. If there is a creature role in the model, the model will be bound with the role. According to the requirements of animation, bones are arranged and weights are drawn. For some roles involving cloth simulation, a weight control part and a resolving control part may be differentiated by a vertex map. For a fluid part, image encoding processing may be performed on a simulated fluid sequence in the three-dimensional software and a corresponding vertex animation sequence is exported.

The user may come up to the virtual door or perform an indication operation on the virtual door to realize triggering the virtual door.

The indication operation may include: single click, double click, sliding, etc. The present disclosure has no limitation on the indication operation.

It needs to be noted that the number of the game virtual scenes in the game client may be one or more, and the user may independently choose the game virtual scene to experience.

In addition, the virtual door may be in one-to-one correspondence with the game virtual scene so that the user can enter different game virtual scenes through different virtual doors. Specifically, the virtual doors corresponding to different game virtual scenes may have different display identifiers.

Exemplarily, one virtual door corresponds to one unique game virtual scene. When the user triggers one virtual door, the electronic device may display the game virtual scene corresponding to the virtual door for the user.

A plurality of different virtual doors may be simultaneously displayed on the display interface of the game client, and each virtual door has the different display identifier, facilitating selection by the user. Alternatively, one of a plurality of virtual doors may be displayed at a time on the display interface of the game client, and the user may select the position of the virtual door by sliding, thereby selecting one desired virtual door from the plurality of virtual doors.

In addition, the virtual door may be in one-to-many correspondence with the game virtual scenes so that the user can enter different game virtual scenes through one virtual door.

Exemplarily, the virtual door may be in one-to-many correspondence with the game virtual scenes so that the user can enter different game virtual scenes through one virtual door.

According to the method for constructing a virtual scene provided in the embodiments of the present disclosure, by constructing a virtual door for entering a game virtual scene in the real world in response to a game starting event triggered by a user, “crossing” from a scene of the real world to a virtual scene of a game world is realized, allowing for immersively experience the game for the user; and by displaying the game virtual scene in response to the user triggering the virtual door, the user is allowed to have effective experience of the virtual scene of the game world in the scene of the real world. The interestingness of the game is enhanced, thereby improving the user's entertainment experience.

FIG. 4 is a flowchart of another method for constructing a virtual scene provided in an embodiment of the present disclosure. This embodiment is based on the foregoing embodiments. Further, before S120, the method of the present embodiment may further include the following step.

S111, updating the first interface based on a movement of the terminal device.

Wherein, the user may hold the terminal device in hand to move in the scene of the real world, and then the locating icon may be again displayed on the new shot interface along with the movement trajectory of the user. Thus, the first interface may be updated along with the movement of the terminal device.

Exemplarily, the shot interface of the terminal device at the current moment is region A, and after the terminal device is moved, the shot interface at the current moment is switched to region B. At this time, the electronic device may re-determine the position of the locating icon in the region B to update the first interface, thus guaranteeing that the first interface always includes the locating icon during the movement of the terminal device.

It needs to be noted that the region A and the region B may be the same shot region. That is, a region included in the region A completely coincides with a region included in the region B.

Alternatively, the region A and the region B may be different shot regions, where the region included in the region A may partially coincide with the region included in the region B, or the region included in the region A may be completely independent of the region included in the region B.

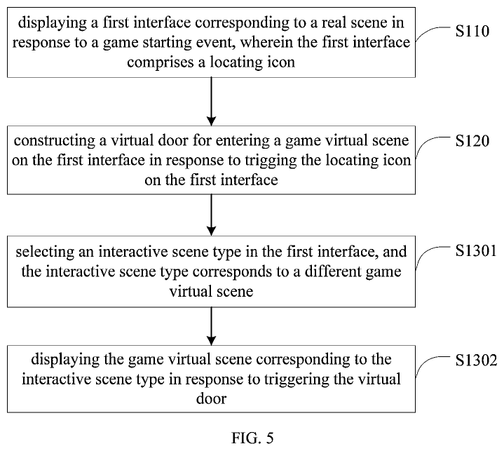

FIG. 5 is a flowchart of a further another method for constructing a virtual scene provided in an embodiment of the present disclosure. This embodiment is based on the foregoing embodiment, where one possible implementation of S130 is as follows.

S1301, selecting an interactive scene type in the first interface, where the interactive scene type corresponds to a different game virtual scene.

The electronic device may display the interactive scene type on the first interface of the game client, facilitating the selection of the desired game virtual scene by the user.

Each interactive scene type may correspond to one or more game virtual scenes. If the interactive scene type is adventure, the corresponding game virtual scenes may be haunted house adventure, jungle adventure, and the like.

The user may determine one interactive scene type selected based on a trigger to one interactive scene type on the first interface. After an interactive scene type is selected, if the interactive scene type corresponds to a plurality of game virtual scenes, a plurality of game virtual scenes may be continuously displayed in the first interface for the user to choose a scene. If the interactive scene type corresponds to one game virtual scene, the electronic device may display the game virtual scene corresponding to the interactive scene type directly in response to triggering the virtual door.

In addition, the user may also determine at least two interactive scene types selected by triggering the at least two interactive scene types on the first interface. At this time, a reservation mode may be entered, in which the electronic device may, after responding to triggering the virtual door, display the game virtual scene corresponding to a first interactive scene selected by the user in the game client and continue to display the game virtual scene corresponding to a second interactive scene after the user finishes the first one. Thus, the game experience consistency of the user is effectively improved.

S1302, displaying the game virtual scene corresponding to the interactive scene type in response to triggering the virtual door.

There may be a plurality of game virtual scenes, as specifically described in the following example.

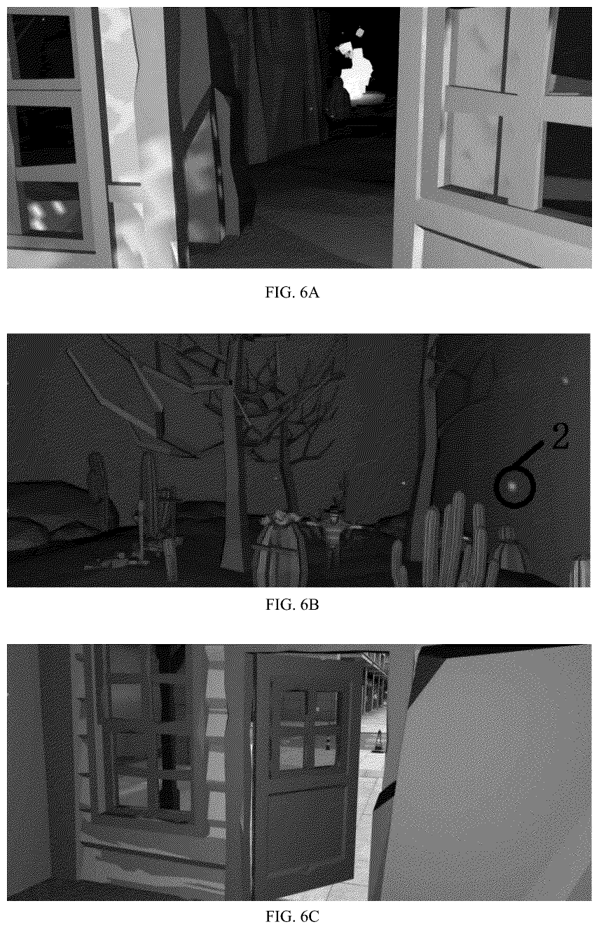

FIG. 6A is a display interface of an adventure game virtual scene. After entering the display interface of the virtual door, the user may walk on the ground in the scene of the real world and may view virtual objects in the game virtual scene by moving the terminal device at rotation angles. When entering a dark game virtual scene, a lighting device may be bound at the position of the camera of the game to illuminate the haunted house environment. The place that the lighting device can cover is visible to the user, and other places are invisible to the user.

Some particle effects may be added to a game virtual scene to effectively heighten the scene atmosphere. The particle effects may be as shown exemplarily by particles 2 in FIG. 6B.

The user may click on the screen to pick up props in the scene. Meanwhile, switching and throwing away of props may be realized based on specified actions in the display interface. The props may be manipulated by clicking on a specified region in the display interface to attack enemies appearing.

In addition, in the process of experiencing in a scene, the user may freely choose to terminate playing or wait for automatic ending after a task is finished. At this time, a showing interface exemplarily shown in FIG. 6C will be displayed in the display interface, and the user may walk out of the virtual door and go back to the scene of the real world.

Based on the description of the foregoing embodiments, a virtual collider may be set at a corresponding preset position the terminal device used by the user in the game virtual scene. The virtual collider may be used to determine a position distance of the terminal device and the virtual door.

In the present disclosure, alternatively, the displaying the game virtual scene corresponding to the interactive scene type in response to triggering the virtual door includes:

upon detecting that a distance between position coordinates of the virtual collider and position coordinates of the virtual door is smaller than a first preset threshold, displaying the game virtual scene corresponding to the interactive scene type.

The user may walk on the ground of the real world to move the terminal device. The electronic device may display the game virtual scene corresponding to the interactive scene type in the first interface upon detecting that the distance between the position coordinates of the virtual collider and the position coordinates of the virtual door is smaller than the first preset threshold.

The first preset threshold may be a variable value set based on experience needs, which will not be particularly limited in the present disclosure.

After the virtual door is constructed in the first interface, the virtual scene of the game world corresponding to the real world has also been constructed. The terminal device may be present in both of the virtual scene of the game world and the scene of the real world. However, the virtual collider on the terminal device may detect a positional relationship between the terminal device and a real object in the real world in real time.

Thus, after the construction of the virtual door is completed, the distance between the position coordinates of the virtual collider and the position coordinates of the virtual door is detected in real time to open the virtual door when an opening condition for opening the virtual door is met, and the game virtual scene corresponding to the interactive scene type is displayed directly so that the user can enter the game experience the game without awareness.

In the scene of the real world, the user can see only the model of the virtual door itself, and may see the virtual scene of the game world after entering the door. In the present disclosure, based on the ColorMask performance of Shader in OpenGL, the surrounding walls are made to have an effect of only deep shearing but which are not rendered, and thus create invisible walls around the virtual door. Thus, the range surrounded by the invisible walls cannot be rendered but maintains a depth, which may not affect that the user explores the virtual scene from inside.

As the user enters the game virtual scene through the virtual door to play, the virtual collider may also detect position information of a real object included in the real scene to provide an anti-collision prompt for the user.

In the present embodiment, alternatively, after displaying the game virtual scene, the method further includes:
obtaining a position information of the virtual collider; and
determining collision warning prompt information according to the position information of the virtual collider and the position information of the real object in the real scene.

The virtual collider may be a collision detection ball set to surround the terminal device to detect whether a virtual reality anchor point of each frame is within the current circular detection region.

Alternatively, the virtual collider may be a collision detection ball set outside the terminal device, and by monitoring a relative distance between the collision detection ball and a static object in the real world in real time, whether an anti-collision warning prompt is provided is determined.

The position information of the virtual collider may change as the user walks, and the collision warning prompt information is determined based on the position information of the virtual collider changing in real time and the position information of the real object in the real scene. Thus, collision safety warning can be provided when the user plays the game, guaranteeing the game experience safety of the user.

Wherein, the collision warning prompt information may be specifically implemented in a plurality of ways as follows.

In some embodiments, the determining the collision warning prompt information according to the position information of the virtual collider and the position information of the real object in the real scene includes:
upon detecting that a distance between the position coordinates of the virtual collider and position coordinates of the real object in the real scene is smaller than a second preset threshold, displaying first prompt information in a target interface corresponding to the game virtual scene.

The electronic device may monitor the position coordinates of the virtual collider in real time, and obtains the position coordinates of the real object in the real scene in real time, and determines the distance between the position coordinates of the virtual collider and the position coordinates of the real object in the real scene. Upon detecting that the distance between the position coordinates of the virtual collider and the position coordinates of the real object in the real scene is smaller than the second preset threshold, the first prompt information is displayed in the target interface corresponding to the game virtual scene, thereby attracting the user's attention. Thus, providing the user with the anti-collision warning prompt is realized.

The second preset threshold may be a variable value set based on experience needs, which will not be particularly limited in the present disclosure.

The displaying the first prompt information in the target interface corresponding to the game virtual scene may include:
highlighting a coordinate region of the real object in the target interface corresponding to the game virtual scene;
or, displaying an anti-collision indication icon at a position where the real object is located in the target interface corresponding to the game virtual scene.

The electronic device may display the first prompt information in the target interface corresponding to the game virtual scene, causing the user to take notice of the real object in the scene of the real world in the process of playing the game. Thus, the problem that the user is unintentionally harmed by the real object in the scene of the real world in the process of playing the game can be avoided.

The electronic device may highlight a coordinate region of the real object in the target interface corresponding to the game virtual scene.

Exemplarily, the electronic device may display the coordinate region of the real object by setting a color with high brightness in the target interface corresponding to the game virtual scene: or, the electronic device may display the coordinate region of the real object by setting high brightness and low brightness at the coordinate region of the real object in the target interface corresponding to the game virtual scene: or, the electronic device may display the coordinate region of the real object by setting the border of the coordinate region of the real object to scale up and scale down orderly in the target interface corresponding to the game virtual scene.

Wherein, the electronic device may display an anti-collision indication icon at the position where the real object is located in the target interface corresponding to the game virtual scene.

Exemplarily, the electronic device may display a warning icon at the position where the real object is located in the target interface corresponding to the game virtual scene, a size of the warning icon may be set correspondingly according to the coordinate region of the real object, or a color depth of the warning icon may be set correspondingly according to the coordinate region of the real object, thereby distinguishing the volume of the real object. Thus, quantitative prompts can be provided for the user.

In some other embodiments, the determining the collision warning prompt information according to the position information of the virtual collider and the position information of the real object in the real scene includes:
upon detecting that the distance between the position coordinates of the virtual collider and the position coordinates of the real object in the real scene is smaller than the second preset threshold, generating second prompt information, where the second prompt information is used for providing an anti-collision warning voice prompt.

The electronic device may monitor the position coordinates of the virtual collider in real time, and obtains the position coordinates of the real object in the real scene in real time, and determines the distance between the position coordinates of the virtual collider and the position coordinates of the real object in the real scene. Upon detecting that the distance between the position coordinates of the virtual collider and the position coordinates of the real object in the real scene is smaller than the second preset threshold, the second prompt information is generated, thereby directly attracting the user's attention. Thus, providing the user with the effective and accurate anti-collision warning prompt is realized.

The second preset threshold may be a variable value set based on experience needs, which will not be particularly limited in the present disclosure.

It needs to be noted that the second prompt information may be voice warning prompt information, thereby providing the user with more effective anti-collision warning prompt without affecting the user's game experience.

The second prompt information may be specifically implemented in a plurality of ways as follows.

In some embodiments, the electronic device may generate voice warning information upon detecting that the distance between the position coordinates of the virtual collider and the position coordinates of the real object in the real scene is smaller than the second preset threshold, where the voice warning information may include orientation information of the position coordinates of the real object in the real scene relative to the user, e.g., information such as on the left and on the right of the user.

In some other embodiments, the electronic device may generate vibration warning information upon detecting that the distance between the position coordinates of the virtual collider and the position coordinates of the real object in the real scene is smaller than the second preset threshold, and as the distance between the position coordinates of the virtual collider and the position coordinates of the real object in the real scene gets smaller, the strength of vibration becomes greater. Thus, the user may be reminded of an anti-collision event in the process of playing the game by vibration manner of the terminal device, and therefore, the user may reselect a walking path for playing the game.

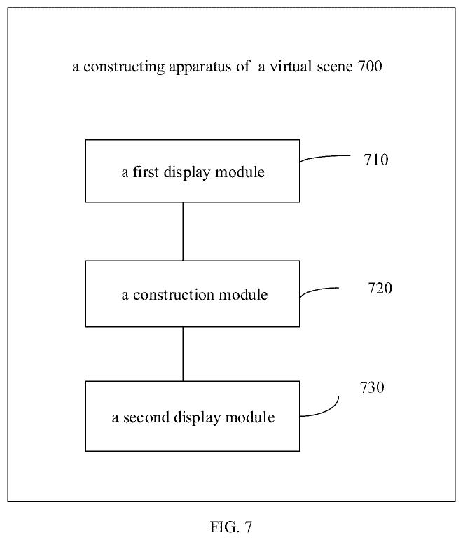

FIG. 7 is a structural schematic diagram of an apparatus for constructing a virtual scene provided in the present disclosure. As shown in FIG. 7, the apparatus 700 for constructing a virtual scene provided in the present embodiment includes a first display module 710, a construction model 720, and a second display module 730.

The first display module 710 is configured to display a first interface corresponding to a real scene in response to a game starting event, where the first interface includes a locating icon.

The construction module 720 is configured to construct a virtual door for entering a game virtual scene on the first interface in response to trigging the locating icon on the first interface.

The second display module 730 is configured to display the game virtual scene in response to trigging the virtual door.

In the present embodiment, alternatively, the apparatus further includes an updating module.

The updating module is configured to update the first interface based on a movement of a terminal device.

In the present embodiment, alternatively, the second display module 730 includes a selection unit and a display unit.

The selection unit is configured to select an interactive scene type in the first interface, where the interactive scene type corresponds to a different game virtual scene.

The display unit is configured to display the game virtual scene corresponding to the interactive scene type in response to triggering the virtual door.

In the present embodiment, alternatively, the display unit is specifically configured to:
upon detecting that a distance between position coordinates of a virtual collider and position coordinates of the virtual door is smaller than a first preset threshold, display the game virtual scene corresponding to the interactive scene type, where the virtual collider is set at a preset position of the terminal device in the game virtual scene.

In the present embodiment, alternatively, the apparatus of the present embodiment further includes an obtaining module and a determination module.

The obtaining module is configured to obtain position information of the virtual collider.

The determination module is configured to determine collision warning prompt information according to the position information of the virtual collider and position information of a real object in the real scene.

In the present embodiment, alternatively, the determination module is specifically configured to:
upon detecting that a distance between the position coordinates of the virtual collider and position coordinates of the real object in the real scene is smaller than a second preset threshold, display first prompt information in a target interface corresponding to the game virtual scene.

In the present embodiment, alternatively, the determination module is specifically configured to:
highlight a coordinate region of the real object in the target interface corresponding to the game virtual scene;
or, display an anti-collision indication icon at a position the real object is located in the target interface corresponding to the game virtual scene.

In the present embodiment, alternatively, the determination module is specifically configured to:
upon detecting that the distance between the position coordinates of the virtual collider and the position coordinates of the real object in the real scene is smaller than the second preset threshold, generate second prompt information, where the second prompt information is used for providing an anti-collision voice warning prompt.

The apparatus for constructing a virtual scene provided in the present disclosure may be used to implement the method embodiments described above, and may follow similar implementation principles and have similar technical effects to the method embodiments, which will not be redundantly described herein.

Exemplarily, the present disclosure provides an electronic device, including: one or more processors: a memory; and one or more computer programs, where the one or more computer programs are stored in the memory, and the one or more processors, when executing one or more computer programs, cause(s) an electronic device to implement the method for constructing a virtual scene presented in the foregoing embodiments.

Exemplarily, the present disclosure provides a chip system applied to an electronic device including a memory and a sensor. The chip system includes: a processor configured to perform the method for constructing a virtual scene presented in the foregoing embodiments.

Exemplarily, the present disclosure provides a computer-readable storage medium on which a computer program is stored, where the computer program, when executed by a processor, causes an electronic device to perform the method for constructing a virtual scene presented in the foregoing embodiments.

Exemplarily, the present disclosure provides a computer program product, which, when running on a computer, causes the computer to perform the method for constructing a virtual scene presented in the foregoing embodiments.

In the above embodiments, all or a portion of the functions may be achieved by software, hardware, or a combination of software and hardware. When the functions are implemented by using software, it can be implemented in whole or in part in the form of a computer program product. A computer program product includes one or more computer instructions. When computer program instructions are loaded and executed on a computer, a process or function in accordance with embodiments of the present disclosure is generated, in whole or in part. A computer may be a general-purpose computer, a special purpose computer, a computer network, or other programmable device. Computer instructions may be stored in computer-readable storage medium. A computer-readable storage medium may be any available medium that a computer can access or a data storage device such as a server or data center that contains one or more available medium integrated. The available medium may be magnetic medium (for example, floppy disk, hard disk, magnetic tape), optical medium (for example, DVD), or semiconductor medium (for example, solid state disk (SSD)).

It should be noted that the relationship terms, such as “first” and “second”, mentioned in the present disclosure are only used to distinguish different one entity or operation with another entity or operation, and are not intended to need or imply that there is any such practical relationship or order between these entities or operations. Furthermore, the terms “include”, “contain” or any other variation thereof is intended to cover non-exclusive inclusion, so that a process, method, article or equipment comprising a set of elements includes not only those elements but also other elements not expressly listed, or elements inherent to such process, method, article or equipment. In the absence of further restrictions, the element which is defined by the sentence “including a . . . ” does not preclude the existence of additional identical elements in a process, method, article or device comprising the elements.

The foregoing are only embodiments of the present disclosure in such a way as to enable those skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to these embodiments described herein, but will conform to the broadest scope consistent with the principles and novel features disclosed herein.

1. A method for constructing a virtual scene, comprising:
displaying a first interface corresponding to a real scene in response to a game starting event, wherein the first interface comprises a locating icon;
constructing a virtual door for entering a game virtual scene on the first interface in response to trigging the locating icon on the first interface; and
displaying the game virtual scene in response to trigging the virtual door.

2. The method according to claim 1, before the constructing the virtual door for entering the game virtual scene on the first interface in response to trigging the locating icon on the first interface, further comprising:
updating the first interface based on a movement of a terminal device.

3. The method according to claim 1, wherein the displaying the game virtual scene in response to trigging the virtual door comprises:
selecting an interactive scene type in the first interface, wherein the interactive scene type corresponds to a different game virtual scene; and
displaying the game virtual scene corresponding to the interactive scene type in response to triggering the virtual door.

4. The method according to claim 3, wherein the displaying the game virtual scene corresponding to the interactive scene type in response to triggering the virtual door comprises:
upon detecting that a distance between position coordinates of a virtual collider and position coordinates of the virtual door is smaller than a first preset threshold, displaying the game virtual scene corresponding to the interactive scene type, wherein the virtual collider is arranged at a preset position of the terminal device in the game virtual scene.

5. The method according to claim 4, after the displaying the game virtual scene, further comprising:
obtaining position information of the virtual collider; and
determining collision warning prompt information according to the position information of the virtual collider and position information of a real object in the real scene.

6. The method according to claim 5, wherein the determining collision warning prompt information according to the position information of the virtual collider and the position information of the real object in the real scene comprises:
upon detecting that a distance between the position coordinates of the virtual collider and position coordinates of the real object in the real scene is smaller than a second preset threshold, displaying a first prompt information in a target interface corresponding to the game virtual scene.

7. The method according to claim 6, wherein the displaying the first prompt information in a target interface corresponding to the game virtual scene comprises:
highlighting a coordinate region of the real object in the target interface corresponding to the game virtual scene;
or, displaying an anti-collision indication icon at a position where the real object is located in the target interface corresponding to the game virtual scene.

8. The method according to claim 5, wherein the determining the collision warning prompt information according to the position information of the virtual collider and the position information of the real object in the real scene comprises:
upon detecting that the distance between the position coordinates of the virtual collider and the position coordinates of the real object in the real scene is smaller than the second preset threshold, generating a second prompt information, wherein the second prompt information is used for providing an anti-collision voice warning prompt.

9. A constructing apparatus of a virtual scene, comprising:
a first display module, configured to display a first interface corresponding to a real scene in response to a game starting event, wherein the first interface comprises a locating icon;
a construction module, configured to construct a virtual door for entering a game virtual scene on the first interface in response to trigging the locating icon on the first interface; and
a second display module, configured to display the game virtual scene in response to trigging the virtual door.

10. An electronic device, comprising: one or more processors; a memory; and one or more computer programs, wherein the one or more computer programs are stored in the memory, and the one or more processors, when executing the one or more computer programs, make(s) the electronic device to implement the method for constructing a virtual scene according to claim 1.

11. A computer storage medium, comprising computer instructions, wherein when the computer instructions run on an electronic device, the electronic device performs the method for constructing the virtual scene according to claim 1.

12. A computer program product, which, when running on a computer, causes the computer to perform the method for constructing a virtual scene according to claim 1.

13. The method according to claim 2, wherein the displaying the game virtual scene in response to trigging the virtual door comprises:
selecting an interactive scene type in the first interface, wherein the interactive scene type corresponds to a different game virtual scene; and
displaying the game virtual scene corresponding to the interactive scene type in response to triggering the virtual door.

14. The method according to claim 2, after the displaying the game virtual scene, further comprising:
obtaining position information of the virtual collider; and
determining collision warning prompt information according to the position information of the virtual collider and position information of a real object in the real scene.

15. The method according to claim 3, after the displaying the game virtual scene, further comprising:
obtaining position information of the virtual collider; and
determining collision warning prompt information according to the position information of the virtual collider and position information of a real object in the real scene.

16. The method according to claim 5, wherein the determining the collision warning prompt information according to the position information of the virtual collider and the position information of the real object in the real scene comprises:
upon detecting that the distance between the position coordinates of the virtual collider and the position coordinates of the real object in the real scene is smaller than the second preset threshold, generating a voice warning information.

17. The method according to claim 5, wherein the determining the collision warning prompt information according to the position information of the virtual collider and the position information of the real object in the real scene comprises:
upon detecting that the distance between the position coordinates of the virtual collider and the position coordinates of the real object in the real scene is smaller than the second preset threshold, generating a vibration warning information.

18. The constructing apparatus of a virtual scene according to claim 9, further comprises:
an updating module, configured to update the first interface based on a movement of a terminal device.

19. The constructing apparatus of a virtual scene according to claim 9, wherein the second display module comprises:
a selection unit, configured to select an interactive scene type in the first interface, wherein the interactive scene type corresponds to a different game virtual scene and a display unit; and
a display unit, configured to display the game virtual scene corresponding to the interactive scene type in response to triggering the virtual door.

20. The constructing apparatus of a virtual scene according to claim 9, further comprises:
an obtaining module, configured to obtain position information of the virtual collider; and
a determination module, configured to determine collision warning prompt information according to the position information of the virtual collider and position information of a real object in the real scene.
